(19) United States
(12) Patent Application Publication
(10) Pub. No.: US 2010/0251911 A1
(43) Pub. Date: Oct. 7, 2010

(54) FLEXIBLE DIE

(75) Inventor: Masahiro Nakata, Osaka (JP)

Correspondence Address: WENDEROTH, LIND & PONACK, L.L.P., 1030 15th Street, N.W.,, Suite 400 East, Washington, DC, 20005-1503, US

(73) Assignee: TSUKATANI HAMONO MFG. CO., LTD., Yao-shi, Osaka (JP)

(21) Appl. No.: 12/740,035

(22) PCT Filed: Dec. 16, 2008
(86) PCT No.: PCT/JP2008/072855

§ 371 Date: Apr. 27, 2010

(30) Foreign Application Priority Data
Dec. 17, 2007 (JP) 2007-324866

(51) Int. Cl. B44B 5/02

(52) U.S. Cl. 101/28

(57) ABSTRACT

A flexible die is used in an embossing apparatus in which a pair of flexible bases (2a, 2b) are respectively wrapped around a pair of cylindrical rollers disposed opposing each other, and a sheet to be processed (S) is passed through between the pair of rollers, thereby performing embossing. The pair of flexible bases (2a, 2b) are constituted by a female flexible base (2a) and a male flexible base (2b) that are mated with each other, a line-shaped convex portion (3a) corresponding to the contour of an embossing processing pattern is formed in the female flexible base (2a), and the convex portion (3b) is formed in the male flexible base (2b), the convex portion (3b) being fitted within the area encompassed within the line-shaped convex portion (3a) of the female flexible base while leaving an interval from the inner circumferential surface of the line-shaped convex portion (3a). A concave portion (30) is formed in the convex portion (3b).

### TECHNICAL FIELD

The present invention relates to a flexible die (sheet-shaped blade plate) used for performing embossing on sheet materials (sheets to be processed) such as paper sheets, or plastic sheets (films), for example.

### BACKGROUND ART

As a conventional method for punching, half-cutting or other processing, a method has been employed in which a groove is cut into a the board such as plywood in accordance with a punching pattern, a band-shaped blade (Thomson blade) is then fitted into the cut groove, thereby manufacturing a die, and such a die is mounted in a pressing machine so as to perform punching, half-cutting or other processing on paper sheets, plastic sheets, or the like.

Recently, a method has also been adopted in which a flexible die is manufactured that includes, on one of the surfaces of a flexible base (ferromagnetic body), a cutting blade with a pattern corresponding to the shape of the cutting line, and the flexible die is then wrapped around a magnet roller 301 of a rotary processing device 300 as shown in FIG. 12, thereby performing punching, half-cutting or other processing on paper sheets, plastic sheets, or the like (for example, see patent documents 1 and 2). Note that numerous permanent magnets are embedded in the outer circumferential surface of the magnet roller 301 so that the flexible die is magnetically adhered thereto in a stable manner.

Also for a method in which embossing is performed on the surface of sheet materials such as paper sheets, plastic sheets (films) or the like, a method is adopted in which a flexible die is prepared that has concave and convex portions for embossing in a predetermined pattern formed on one surface of the flexible base (ferromagnetic body), and the flexible die is then similarly wrapped around the magnet roller 301 of the rotary processing device 300, to perform embossing on the surface of plastic sheets, or the like. Note that exemplary flexible dies used for embossing include a flexible die in which a processing convex portion in a predetermined pattern is formed on the surface of the flexible base, a flexible die in which a processing concave portion having a predetermined pattern is formed on the surface of the flexible base, or a flexible die combining these processing convex portion and processing concave portion. Generally, a flexible die with a processing convex portion formed in a planar pattern is used.

Flexible dies as described above are manufactured by machining or etching, and those manufactured by etching are generally called etched dies.

Patent document 1: JP 2000-190284A
Patent document 2: JP 2002-221220A

### DISCLOSURE OF INVENTION

### Problems to be Solved by the Invention

Incidentally, with the flexible die described above that includes a processing convex portion formed in a planar pattern, the wrapping properties of the flexible die with respect to the magnet roller may deteriorate, which sometimes results in a condition in which a part of the flexible base is lifted from the outer circumferential surface of the magnet roller, which is also referred to as “base lift”.

For example, in a flexible die 401 that has embossing convex portions 403 in a processing pattern P formed on the surface of a flexible base 402 as illustrated in FIGS. 13 and 14, the rigidity in the portions where the embossing convex portions 403 are formed (the flexural rigidity in a roller wrapping direction R) is high, making the die hard to bend. For this reason, as shown in FIG. 15, “base lift” occurs in the area between the processing patterns P of the embossing convex portions 403 when the flexible die 401 is wrapped around the magnet roller 301, which makes accurate embossing impossible.

Furthermore, an embossing apparatus has been proposed in which flexible dies are wrapped around, respectively, a pair of cylindrical rollers that are disposed opposing each other, and a sheet to be processed is caused to pass through between the pair of rollers, thereby performing embossing. A flexible die used for this embossing apparatus also has an embossing convex portion formed on the flexible base in a planar shape, and therefore the “base lift” occurs in the area between the processing patterns P of the embossing convex portions 403, causing the problem that accurate embossing cannot be performed.

The present invention has been achieved in consideration of such circumstances, and aims at providing flexible dies that can be wrapped around cylindrical rollers such as a magnet roller without “base lift”.

### Means for Solving the Problems

The present invention provides a flexible die used in an embossing apparatus in which a pair of flexible bases, each having an embossing convex portion formed on one surface, are respectively wrapped around a pair of cylindrical rollers disposed opposing each other, and a sheet to be processed is passed through between the pair of rollers, thereby performing embossing, wherein the pair of flexible bases are constituted by a female flexible base and a male flexible base that can be mated with each other, a line-shaped convex portion corresponding to a contour of an embossing processing pattern is formed in the female flexible base, and a convex portion that is fitted within an area encompassed within the line-shaped convex portion of the female flexible base while leaving an interval from the inner circumferential surface of the line-shaped convex portion is formed in the male flexible base, a concave portion being formed in the convex portion of the male flexible base.

With the present invention, the embossing convex portion formed in the female flexible base is formed as a line-shaped convex portion that corresponds to the contour of the embossing pattern. So the rigidity of the portions where the embossing convex portions are formed (flexural rigidity in the roller wrapping direction R) is significantly smaller than that of the processing convex portions formed in a planar pattern, and therefore the flexible die bends easily. Consequently, attaching the flexible die to the roller without “base lift” is possible, thereby enabling accurate embossing.

Also the male flexible base has formed therein a convex portion that is fitted within the area encompassed within the line-shaped convex portion of the female flexible base while leaving an interval from the inner circumferential surface of the line-shaped convex portion. Since a concave portion is formed in the convex portion, the embossing convex portion formed in the male flexible base is also formed in a line shape. Accordingly, the rigidity of the portions where the embossing convex portions are formed (flexural rigidity in the roller wrapping direction R) is significantly smaller than that of the processing convex portions formed in a planar pattern, thereby making it possible for the flexible die to bend easily. As a result, attaching the flexible die to the roller without “base lift” is possible, thereby enabling accurate embossing. Moreover, the convex portion of one flexible base is formed so as to be fitted within the area in the other flexible base where the line-shaped convex portion is formed while leaving an interval from the line-shaped convex portion. Therefore, as a result of the one flexible base and the other flexible base being fitted to each other, accurate and clear embossing is achieved.

With the flexible die configured as above of the present invention, in a back face of the face of the flexible base on which the embossing convex portion is formed, a furrow is formed at least in a portion that corresponds to the back side of an area where the embossing convex portion is formed.

In the present invention, a single furrow may be formed on the other face (back face) of the flexible base. Also, a plurality of furrows may be formed on the other face (back face) of the flexible base at predetermined pitches along the direction in which the flexible die is wrapped on the roller. When a plurality of furrows are formed, it is possible to form the furrows across approximately the entire surface of the other face (back face) of the flexible base. Also, it is desirable that the furrows are formed so as to extend in a direction intersecting the roller wrapping direction R, particularly, a direction perpendicular to the roller wrapping direction R.

With the present invention, since a plurality of furrows (or a single furrow) are formed on the other face (the back face of the face where the embossing convex portion is formed) of the flexible base, the flexural rigidity is reduced in the portions where furrows are formed, making it possible for the portions where the embossing convex portions are formed to bend easily. Therefore, even with a pattern in which a cutting blade or embossing convex portions are locally concentrated, or a pattern in which many embossing convex portions are present that extend in the roller wrapping direction, by forming a plurality of furrows (or a single furrow) on the back face of the embossing convex portions, the portions where the embossing convex portions are formed bend easily along the outer circumferential surface of the roller when the flexible die is wrapped around the roller. As a result, it becomes possible to attach the flexible die to the roller without “base lift”.

Note that the present invention can be applied to a flexible die mounted in a roller that does not include a magnet (permanent magnet), in addition to flexible dies mounted in a magnet roller for use.

### EFFECTS OF THE INVENTION

With a flexible die according to the present invention, wrapping the flexible die to a cylindrical roller such as a magnet roller without “base lift” becomes possible, thereby enabling accurate embossing.

### BRIEF DESCRIPTION OF DRAWINGS

FIG. 1 is a front view of an exemplary flexible die of the present invention.

FIG. 2 is a cross-sectional view of a main portion of the flexible die shown in FIG. 1.

FIG. 3 is a cross-sectional view illustrating a flexible die of the present invention.

FIG. 4 is a perspective view schematically illustrating a state in which a flexible die of the present invention is wrapped around a roller.

FIG. 5 is a schematic cross-sectional view schematically illustrating a state in which flexible dies of the present invention are wrapped around rollers.

FIG. 6 is a cross-sectional view illustrating a flexible die of the present invention.

FIG. 7 is a cross-sectional view illustrating a flexible die of the present invention.

FIG. 8 shows the flexible die shown in FIG. 7 as viewed from the back side.

FIG. 9 schematically illustrates an exemplary method for manufacturing a flexible die of the present invention.

FIG. 10 is a cross-sectional view illustrating another example of a flexible die of the present invention.

FIG. 11 is a cross-sectional view illustrating another example of a flexible die of the present invention.

FIG. 12 is a perspective view schematically illustrating a part of a rotary processing apparatus.

FIG. 13 is a front view of an exemplary conventional flexible die.

FIG. 14 is a cross-sectional view of a main portion of the flexible die shown in FIG. 13.

FIG. 15 illustrates a problem that occurs when the flexible die shown in FIG. 13 is wrapped around a magnet roller.

### DESCRIPTION OF REFERENCE NUMERALS

1 Flexible die

2, 2a, 2b Flexible base

3, 3a, 3b Embossing convex portion

30 Concave portion

4 Slit-shaped furrows

P Processing pattern

R Roller wrapping direction

301, 301a, 301b Magnet roller

### BEST MODE FOR CARRYING OUT THE INVENTION

Embodiments of the present invention will be described below with reference to the drawings.

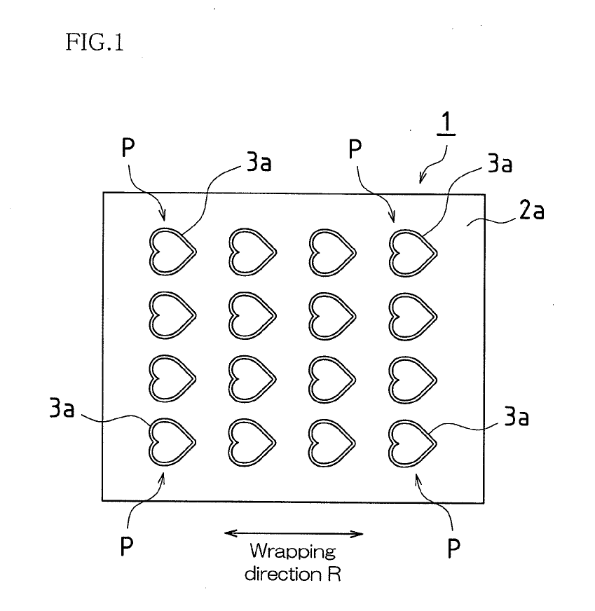

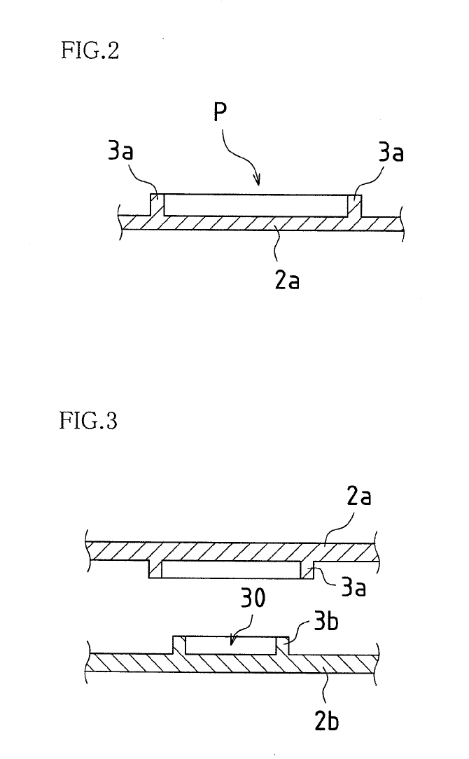

FIG. 1 is a front view of an exemplary flexible die of the present invention. FIG. 2 is a cross-sectional view of a main portion of that flexible die.

A flexible die 1 in this example has an embossing convex portion formed on one of its surfaces, and is used by wrapping a female flexible base 2a and a male flexible base 2b that mate with each other around a pair of cylindrical rollers 301a and 301b that are disposed opposing each other. A line-shaped convex portion 3a corresponding to the contour of an embossing processing pattern P is formed in the female flexible base 2a, and a convex portion 3b that can be fitted within the area encompassed within the line-shaped convex portion 3a while leaving an interval from the inner circumferential surface of the line-shaped convex portion 3a is formed in the male flexible base 2b, and a concave portion 30 is formed in the convex portion 3b (see FIG. 3).

The processing pattern P of the present embodiment is heart-shaped. A plurality of processing patterns P are disposed both in a direction perpendicular to a wrapping direction R in which the flexible die 1 is wrapped around a magnet roller 301 (hereinafter also referred to as a roller wrapping direction R), and in a direction along the roller wrapping direction R.

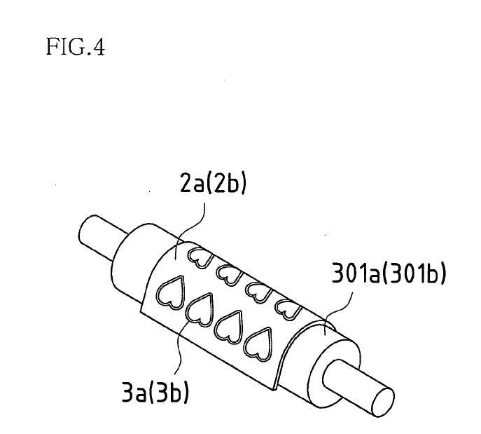

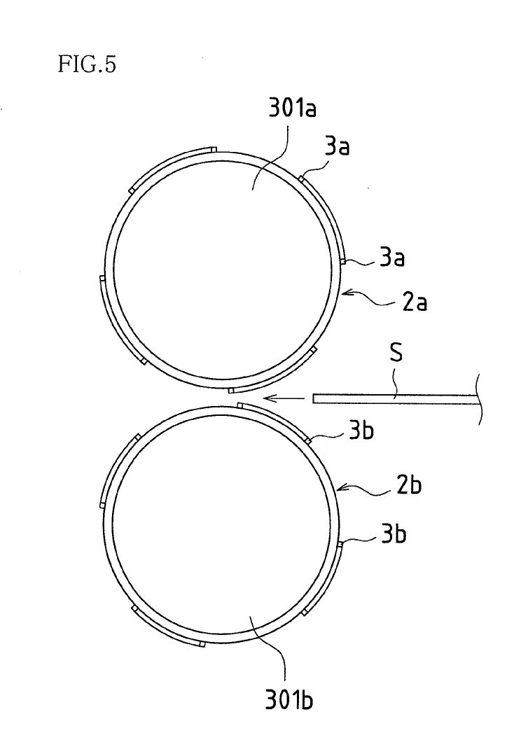

A flexible base 2 configured as above is wrapped around the rotary magnets 301 (301a, 301b) of a rotary processing apparatus as illustrated in FIGS. 4 and 5.

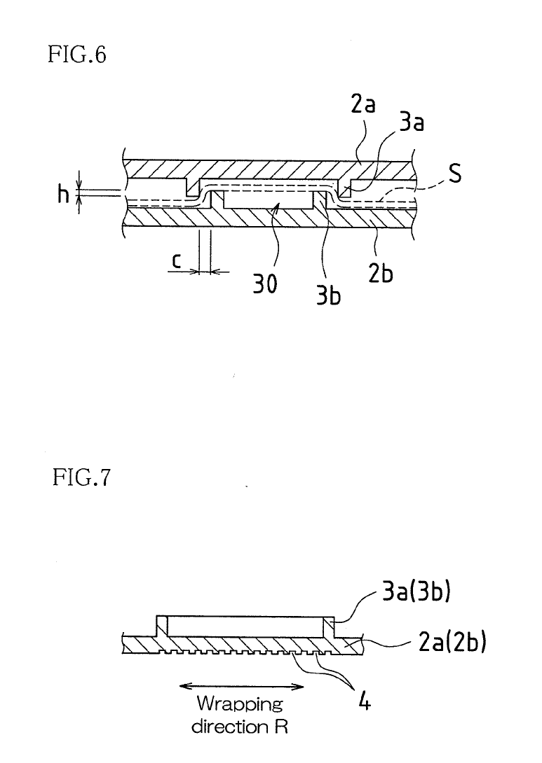

That is, the female flexible base 2a and the male flexible base 2b are wrapped around a pair of cylindrical rollers 301a and 301b that are disposed opposing each other. A sheet S that is to be processed is passed through between the pair of rollers 301a and 301b, the embossing convex portion 3a of the female flexible base 2a and the embossing convex portion 3b of the male flexible base 2b are mated with each other while sandwiching the sheet S therebetween so as to press the sheet S, thereby performing embossing (see FIGS. 5 and 6).

In this a case, the sheet S is drawn as a result of being sandwiched between and pressed by the embossing convex portions 3a and 3b. In addition, as shown in FIG. 6, the sheet S is extended across the embossing convex portions 3b of the male flexible base 2b (in other words, the concave portion 30), drawn at the embossing convex portions 3b.

Note that in the present embodiment, the concave portion 30 in the embossing convex portion 3b of the male flexible base 2b is formed as an open space, however, the concave portion 30 may be filled with a sponge material, rubber member, or the like.

Here, a clearance c between the mating embossing convex portions 3a and 3b, that is, an interval between the inner circumferential surface of the convex portion 3a of the female flexible base 2a and the outer circumferential surface of the convex portion 3b of the male flexible base 2b is preferably set to a value within the range from 20% to 200% the thickness of the sheet S to be processed.

This setting range for the clearance c is based on the experimental results as described below, and is determined as appropriate with regard to the material, thickness or the like of the sheet S.

For example, as a result of the test using a sheet S having a thickness of 0.12 mm formed by Kraft paper, the sheet S was torn when the clearance c was smaller than 40% the paper thickness (approximately 0.05 mm), whereas clear embossing could not be achieved when the clearance c was larger than 200% the paper thickness (0.24 mm). Also, as a result of a test using a film sheet S having a thickness of 0.1 mm formed by PET (polyethylene telephthalate), the sheet S was torn when the clearance c was smaller than 20% the paper thickness (approximately 0.02 mm), whereas clear embossing could not be achieved when the clearance c was larger than 200% the paper thickness (0.2 mm).

On the other hand, a vertical interval (level difference) h between the distal ends of the mating embossing convex portions 3a and 3b is determined as suitable with regard to the material, thickness of the sheet S, and the above-stated clearance c or the like.

Note that in addition to paper or sheets made of resin such as plastic sheets, various sheets such as labels that have a separating paper stuck to the back face thereof can be used as the sheet S used in the present invention.

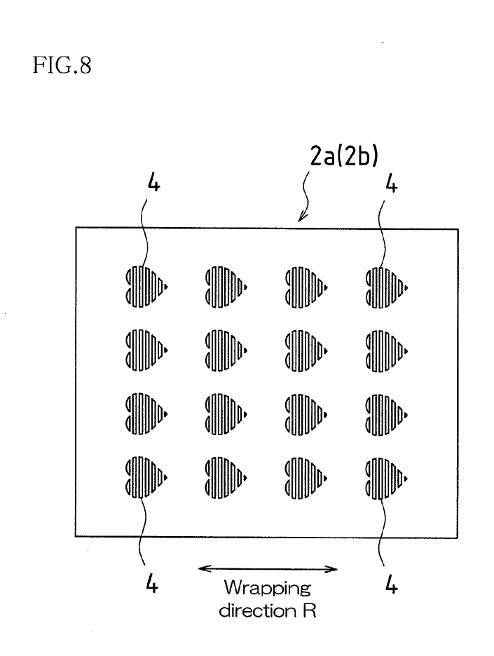

In addition, at least in a portion that corresponds to the back side of the areas where the embossing convex portions 3a and 3b are formed on the other faces of the flexible base 2 (2a, 2b) (the face on the opposite to the face where the embossing convex portions 3a and 3b are formed (back face)), a plurality of slit-shaped furrows 4 that extend in the direction perpendicular to the roller wrapping direction R may be formed at a predetermined pitch in the roller wrapping direction R (see FIGS. 7 and 8). In such a case, the flexural rigidity at portions where the concave portions are formed is reduced, making it easier to bend the portions where the embossing convex portions are formed. Accordingly, when the flexible die is wrapped around the roller, the portions where the embossing convex portions are formed can be bent more readily along the outer circumferential surface of the roller, so it becomes possible to attach the flexible die to the roller without “base lift”.

In this manner, by forming a plurality of slit-shaped furrows (slit-shaped grooves) 4 on the other face of the flexible base 2 (2a, 2b) (back face), in the direction perpendicular to the roller wrapping direction R, the flexible base 2 (2a, 2b) can be wrapped around the magnet roller 301 (301a, 301b) without “base lift”. The reason for this will be described below.

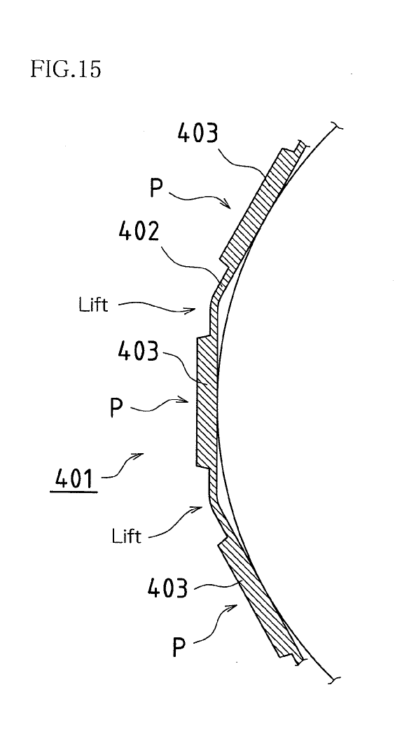

With the flexible die 1 as shown in FIG. 1 in which the embossing convex portion 3 is formed in the processing pattern P, the rigidity at the portions where the embossing convex portion 3 (3a, 3b) is formed is high and those portions do not bend easily. Thus when no furrows are formed on the back face of the flexible base 2 (2a, 2b), the portions where the embossing convex portion 3 is formed (403) undergo little deformation when wrapped around the magnet roller 301, as illustrated in FIG. 15, and consequently “base lift” occurs between the processing patterns P.

In contrast, even though the flexural rigidity at the portions where the embossing convex portion 3 is formed is high, by forming a plurality of furrows 4 that extend in the direction perpendicular to the roller wrapping direction R on the back face of the portions where the embossing convex portion 3 is formed, the portions where the furrows 4 are formed bend and deform when the flexible die 1 is wrapped around the magnet roller 301. Accordingly, the portions where the embossing convex portion 3 is formed are deformed and bend along the outer circumferential surface of the magnet roller 301, so that the flexible die 1 can be attached to the magnet roller 301 without “base lift”. As a result, accurate embossing can be achieved.

The width and depth of the slit-shaped furrows 4 formed on the back face of the flexible base 2 as well as the pitches in the roller wrapping direction R between the slit-shaped furrows 4 can be determined based on experiments, calculations, etc., with regard to the thickness of the flexible base 2, the flexural rigidity of the portions where the embossing convex portion 3 is formed, the curvature of the outer circumferential surface of the magnet roller 301, or the like, such that no “base lift” occurs when the flexible die 1 is wrapped around the magnet roller 301.

Note that although in the examples illustrated in FIGS. 7 and 8, a plurality of furrows 4 are formed, in the back face of the flexible base 2, only in the portions that correspond to the back side of the portions where the embossing convex portion 3 is formed, the present invention is not limited thereto, and the furrows 4 may be formed over substantially the entire region of the back face of the flexible base 2. Also, the cross section of the furrows 4 is not limited to a quadrangular shape, and may have any other shape such as semicircular, triangular, or the like.

Furthermore, in the examples illustrated in FIGS. 7 and 8, a plurality of furrows 4 are formed on the back face of the flexible base 2. However, for example if the pattern width of the embossing convex portion in the wrapping direction R is small, it is also possible to form only a single furrow 4 on the back side of the portion where the embossing convex portion is formed.

In addition, the furrows 4 are not limited to a plurality of slit-shaped furrows that extend in the direction perpendicular to the roller wrapping direction R. For example, the furrows 4 also may be formed in a direction intersecting the roller wrapping direction R.

### Manufacturing Method

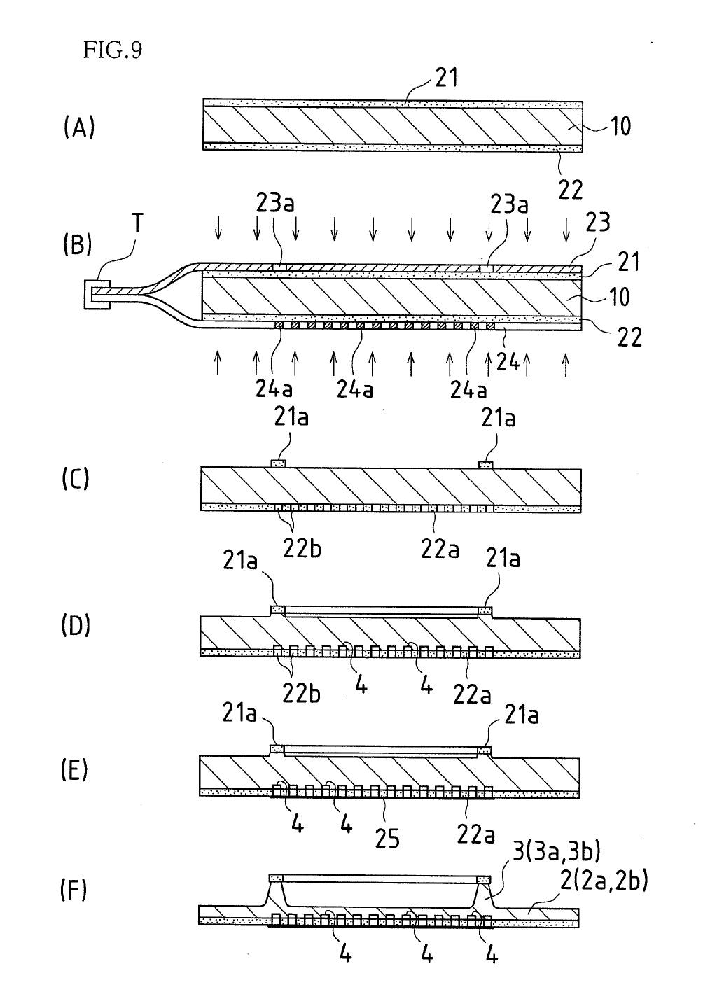

Next, an example of a method for manufacturing the flexible dies shown in FIGS. 7 and 8 will be described with reference to FIG. 9.

Note that although the sizes of the planar shape patterns in which the convex portion 3a and 3b are formed are different, the female flexible base 2a and the male flexible base 2b are manufactured with the same method. Therefore, the manufacturing method described below is common to the female flexible base 2a and the male flexible base 2b, so for the sake of convenience, the terms, flexible base 2 and convex portion 3, are used in the following description.
(1) First, a photomask (negative film) 23 having exposure patterns 23a that correspond to the shape of the embossing convex portion 3 (3a, 3b) in FIG. 1 is obtained by plate making. Also, a photomask (positive film) 24a having exposure patterns in a shape that corresponds to the slit-shaped furrows 4 on the back face of the flexible base 2 (2a, 2b) is obtained by plate making.
(2) As shown in FIG. 9(A), photoresist is evenly applied to the surface of a metal plate 10, and further photoresist is evenly applied to the back face of the metal plate 10, thereby forming photoresist films 21 and 22 on the surface and back face of the metal plate 10, respectively.
(3) As shown in FIG. 9(B), the photomask (negative film) 23 is placed/positioned on the photoresist film 21 on the surface of the metal plate 10, and the photomask (positive film) 24 is also placed/positioned on the photoresist film 22 on the back face of the metal plate 10. Note that the positions of the photomask 23 on the surface side of the metal plate 10 and the photomask 24 on the back side of the metal plate 10 are mutually aligned using a resist mark as reference, and the ends on one side of these photomasks 23 and 24 are joined with an adhesive tape T.
(4) The photoresist films 21 and 22 on the surface and back face of the metal plate 10 are exposed and developed, thereby forming a resist pattern 21a, as well as a resist pattern 22a having openings 22b at the positions corresponding to the plurality of furrows 4 (FIG. 9(C)).
(5) Etching on the metal plate 10 is started while using the resist patterns 21a and 22a on the surface and the back face of the metal plate 10 as a mask; and etching is once suspended when etching has advanced to the depth that corresponds to the depth of the furrows 4 (FIG. 9(D)). Due to this initial etching, a plurality of slit-shaped furrows 4 that extend in the direction perpendicular to the roller wrapping direction R are formed on the back face of the flexible base 2, at equal pitches along the roller wrapping direction R. In this manner, it is possible to control the depth of the furrows 4 with accuracy by performing etching for the furrows 4 first, and therefore the flexural rigidity at the portions where the furrows 4 are formed can be readily adjusted.
(6) As illustrated in FIG. 9(E), the slit-shaped furrows 4 formed by the foregoing etching are protected against etchant by sticking a masking sheet 25 to the back face of the metal plate 10, and etching is resumed in this state. Etching is ended when this secondary etching has advanced to a predetermined depth (depth obtained based on [the height of the embossing convex portion 3 (3a, 3b)]—[the depth of the furrows 4]). As a result of etching performed as described above, as illustrated in FIG. 9(F), the flexible base 2 (2a, 2b) and projections whose cross section has a trapezoidal shape (projecting streaks), i.e., embossing convex portion 3 (3a, 3b), are formed. The masking sheet 25 is removed upon completion of etching. Also, the resist patterns 21a and 22a are removed that remain on the upper surface side and the back side of the flexible base 2.

After the embossing convex portion 3 (3a, 3b) has been formed by etching (after completion of the step in FIG. 9(F)), if necessary, a step may be added in which numerical controlled (NC) machine tool or the like is used so that cutting is performed by a cutting tool at both side faces of the embossing convex portion 3 (3a, 3b) or the like (finishing step, for example).

In the example described above, a plurality of slit-shaped furrows 4 on the back face of the flexible base 2 (2a, 2b) are formed by etching, however, there is no limitation to this. The furrows 4 may be formed by fine machining.

### Other Embodiments

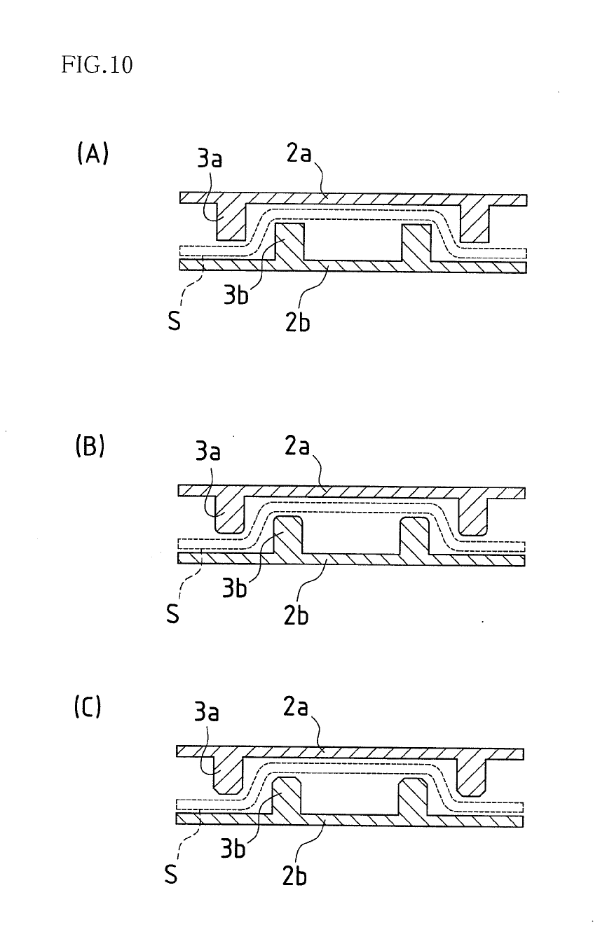

The shape of the embossing convex portion 3 (3a, 3b) is not limited to shapes whose right and left edge portions at the top end are formed to be angular, as illustrated in FIG. 10(A).

For example, as illustrated in FIG. 10(B), the right and left edge portions at the top end of the embossing convex portion 3 (3a, 3b) may be formed in a curved shape, or may be chamfered as illustrated in FIG. 10(C). If the right and left edge portions at the top end of the embossing convex portion 3 (3a, 3b) are formed in a curved shape or chamfered in this manner, the sheet S is not readily torn, which is preferable.

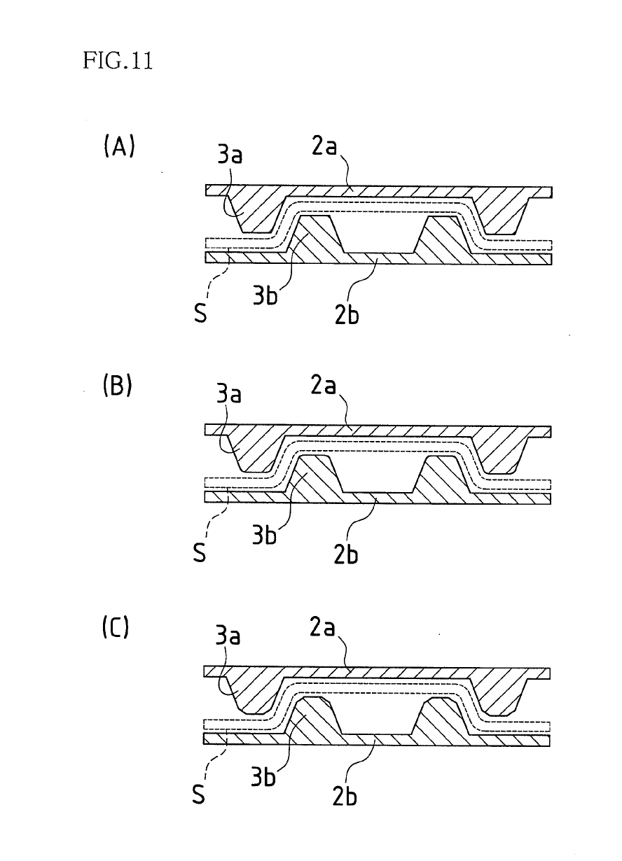

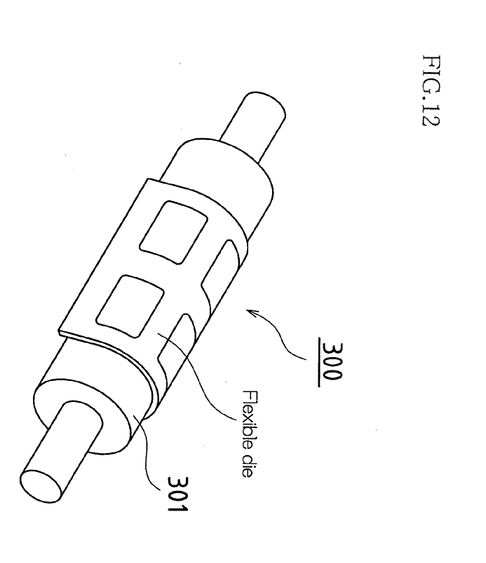

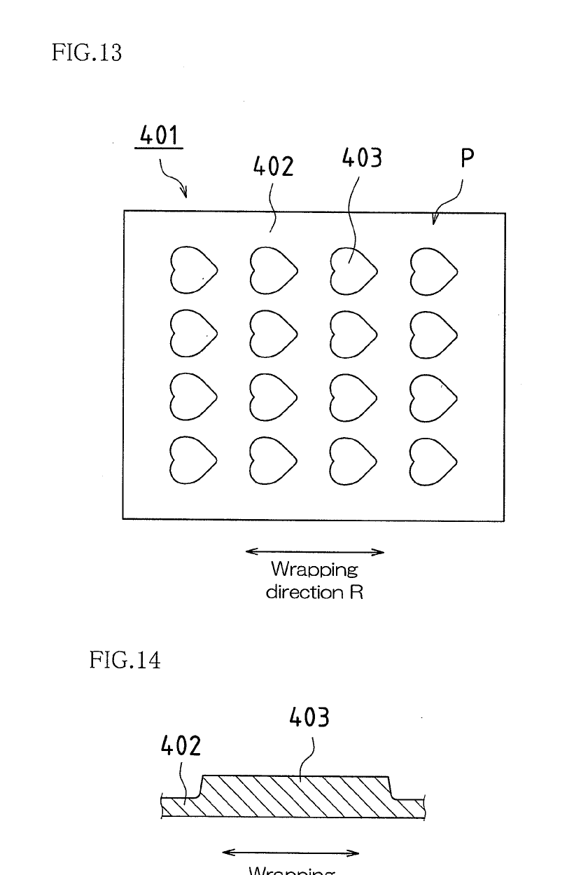

The shape of the embossing convex portion 3 (3a, 3b) may be such that its cross section has a tapered shape as illustrated in FIG. 11(A). In this case as well, the embossing convex portion 3 is not limited to shapes whose right and left edge portions at the top end are formed to be angular. For example, as illustrated in FIG. 11(B), the right and left edge portions at the top end of the embossing convex portion 3 may be formed in a curved shape, or may be chamfered as illustrated in FIG. 11(C). If the right and left edge portions at the top end of the embossing convex portion 3 (3a, 3b) are formed in a curved shape, or chamfered in this manner, the sheet S is not readily torn, which is preferable.

While the embodiments of the present invention have been described so far, the embossing convex portion formed in the flexible die (processing pattern) is not limited to the shape illustrated in FIG. 1. For example, any shape may be used such as a triangle, quadrangle, circle, or patterns of animals, cartoon characters or the like, floral patterns, or letters.

The present invention can be implemented in various other forms without departing from the spirit or principal features of the present invention. The embodiments described above are therefore nothing more than illustrative in every respect, and should not be interpreted in a limiting way. The scope of the present invention is defined by the scope of the claims, and should not be restricted to the foregoing description in any way. Furthermore, all variations and modifications within a scope equivalent to the scope of the claims are encompassed in the scope of the present invention.

This application claims priority on Japanese Patent Application No. 2007-324866 filed in Japan on Dec. 17, 2007. The entire content of the above application is hereby incorporated in the present application by reference. Also, all of the documents cited in the present description are hereby specifically incorporated in the present application in their entirety by reference.

### INDUSTRIAL APPLICABILITY

The flexible die of the present invention can be wrapped around a cylindrical roller such as a magnet roller without “base lift”, and is therefore useful.

1-2. (canceled)

3. A flexible die used in an embossing apparatus in which a pair of flexible bases, each having an embossing convex portion formed on one surface, are respectively wrapped around a pair of cylindrical rollers disposed opposing each other, and a sheet to be processed is passed through between the pair of rollers, thereby performing embossing,
wherein the pair of flexible bases are constituted by a female flexible base and a male flexible base that can be mated with each other,
a line-shaped convex portion corresponding to a contour of an embossing processing pattern is formed in the female flexible base, and a convex portion that is fitted within an area emcompassed within the line-shaped convex portion of the female flexible base while leaving an interval from the inner circumferential surface of the line-shaped convex portion is formed in the male flexible base, a concave portion having such a size that the convex portion of the male flexible base becomes line-shaped being formed in the convex portion of the male flexible base.

4. The flexible die according to claim 3,
wherein in a back face of the face of the flexible base where the embossing convex portion is formed, a furrow is formed at least in a portion that corresponds to the back side of an area where the embossing convex portion is formed.
